(19) United States
(12) Patent Application Publication
(10) Pub. No.: US 2014/0028822 A1
(43) Pub. Date: Jan. 30, 2014

(54) HAIR LOSS MONITOR

(71) Applicants: Alex A. Khadavi, Los Angeles, CA (US); Afshin Shargani, Los Angeles, CA (US)

(72) Inventors: Alex A. Khadavi, Los Angeles, CA (US); Afshin Shargani, Los Angeles, CA (US)

(21) Appl. No.: 13/561,835

(22) Filed: Jul. 30, 2012

(51) Int. Cl. H04N 7/18

(52) U.S. Cl. 348/77; 348/E07.085

(57) ABSTRACT

Systems and methods are provided to measure and record the degree with which the hair loss improves or progresses and to track the change in a user's condition over time.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to hair loss and, more particularly, to methods and systems for identifying and measuring the amount of hair loss over time.

### BACKGROUND

In the United States, by the age of thirty five approximately two-thirds of men will experience significant hair loss. Furthermore, twenty five percent of young men (under age 21) who suffer from Androgenetic alopecia—which is responsible for ninety five percent of hair loss in men—will begin the process of hair loss (i.e., thinning).

Contrary to popular belief, women in the United States are not immune to hair loss. Approximately, forty percent of those who suffer from hair loss in America are female. However, both society and the medical community tend to ignore female hair loss as a real health issue.

The diagnosis of male pattern baldness and female hair loss is grounded in both the appearance and the pattern of hair loss. Therefore, it is important to track a subject's condition over time in order to determine the extent and pattern of loss.

Unfortunately, due to the fact that hair loss has the ability to create severe psychological issues and feelings of anxiety and embarrassment, many who suffer from it are too self-conscious to bring the issue to the attention of their physician or others who may be able to help.

Accordingly, a private means to measure and verify hair loss is desirable.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one or more embodiments, systems and methods are provided to measure and record the degree with which hair loss improves or progresses and to track the change in a user's condition over time. For example, a method for monitoring hair loss may comprise capturing sample images of lost hairs or a thinning area over a period of time and comparing the images to determine whether hair loss is improving or progressing.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 shows a side profile of a person, where a photo enabled computing device is used to capture an image of a thinning area, in accordance with one embodiment.

FIG. 2 illustrates a rear view of a thinning area having a measurable perimeter.

FIG. 3 shows a view of the thinning area illustrated in FIG. 2 as captured in the viewing area of a photo enabled computing device, in accordance with one embodiment.

FIG. 4 is a flow diagram of an exemplary method for monitoring hair loss, in accordance with one embodiment.

FIGS. 5A and 5B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one or more embodiments, program code may be implemented to track an individual's hair loss or thinning hair. The program code may be developed, instrumented or embedded for execution on a general or specialized computing machine. For example, in one option, the program code may be designed as software (hereafter referred to as an “app” by way of example) to run on a modular handheld device such as a cellular phone, a smart phone or any other photo enabled computing device equipped with means (e.g., a camera) to capture one or more images.

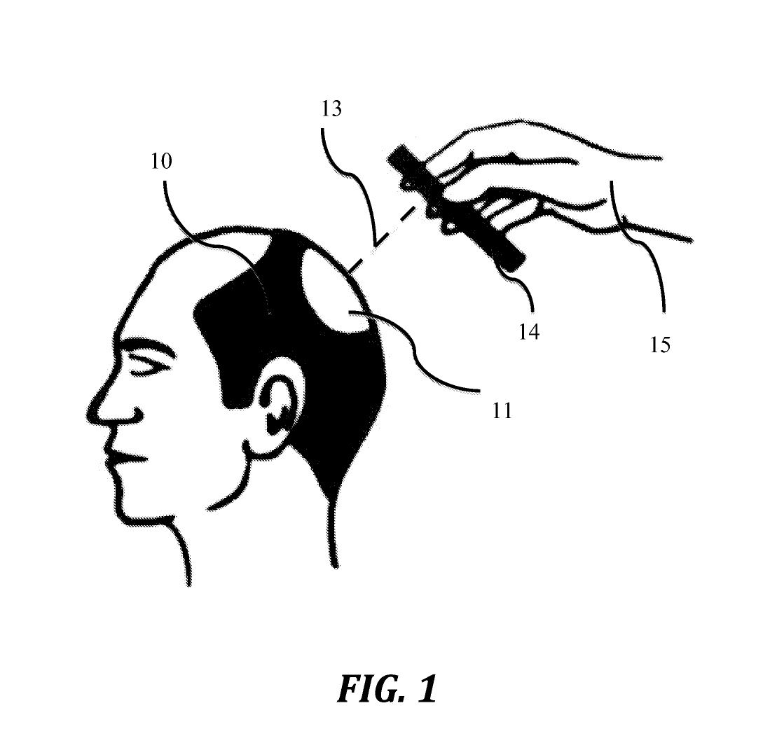

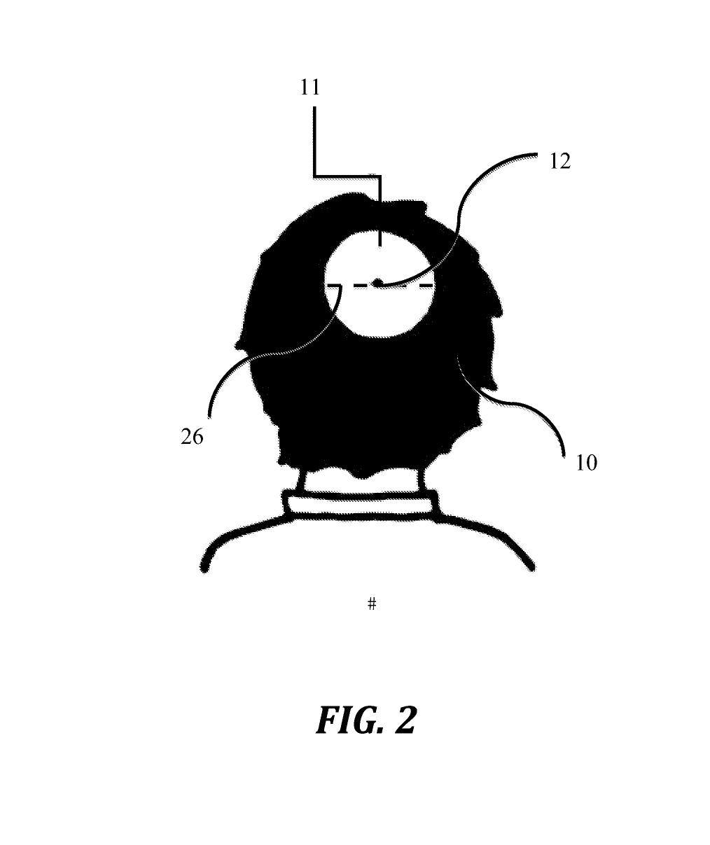

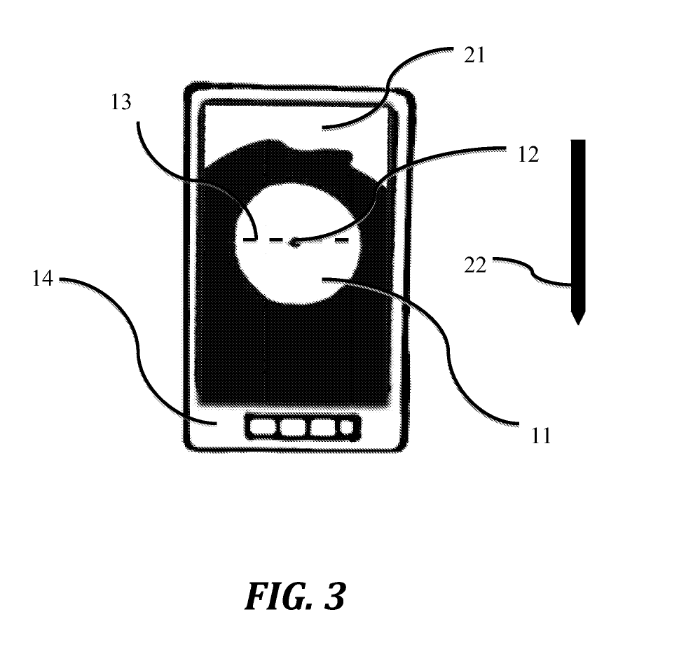

Referring to FIG. 1, the profile of a subject with areas of hair 10 and a thinning area 11 (e.g., a bald spot) is illustrated. A photo enabled computing device 14 as shown may be held by a user 15 at some distance 13 from the thinning area 11 to capture an image of the thinning area 11. FIG. 2 illustrates a view of the thinning area 11, with an approximate center 12 and diameter 26 as viewed if facing the subject from behind. FIG. 3 shows an image of the thinning area 11 captured in the viewing area 21 of the photo enabled computing device 14 with image capturing capabilities. A stylus 22 or other input device such as a finger, pen or mouse for sensitive touch screens may be also utilized to interact with the computing device 14 to capture an image of the thinning area 11.

Referring to FIGS. 1 through 4, in one implementation, an app executed on the photo enabled computing device 14 may be configured to instruct or remind a user to take pictures of the thinning area 11 in regular intervals using the photo enabled computing device 14 (S410). The app may be configured to also assist the user to take pictures from the same distance, angle or lighting condition. In one example, the user may be instructed to position the photo enabled computing device 14 at or near the center of the thinning area 11 and move the photo enabled computing device 14 in a direction away from the target area, for example, at a certain angle. Depending on implementation, the app may automatically cause a picture of the thinning area 11 to be captured, when the image comes into focus or when the photo enabled computing device 14 reaches a certain distance 13 from the start point 12, or when the perimeters of the thinning area 11 are detected.

In some embodiments, to provide for appropriate lighting conditions, the app may use the computing device 14 flash or other illumination tool. For example, if the computing device 14 does not have a flash, the app may instruct the user to create the appropriate lighting conditions so that the pictures taken (preferably, at regularly scheduled time intervals) are uniform with respect to lighting in an attempt to improve the accuracy of the sample pictures taken. Depending on implementation, using image recognition and manipulation tools the app may adjust the brightness, contrast, zoom or rotation of each sample image so that the sample images taken may be appropriately analyzed and compared (e.g., by way of overlapping the images taken over a course of time) (S420). In one example, the app may be configured to create an outline of the thinning area 11 on each sample image taken and overlay the images and the outline to determine if the thinning area is shrinking or enlarging over time.

In one embodiment, the thinning area 11 may be measured automatically by the App based on metrics calculated or obtained (e.g., the perimeter or vertex of the thinning area 11, distance of the device from the center of the thinning area 13, etc.). If automatic measurement of the thinning area 11 is not possible or accurate or if user interaction is needed (S430), the user may intervene to help provide a more accurate measurement (S450). In one implementation, the app may be configured to, for example, superimpose the sample images over a primary image that has been confirmed by the user as a basis point and allow the user to rotate or otherwise manipulate the other images, increase or decrease zoom and increase or decrease brightness and contrast of the images to improve results. The user may also be given the option to create an outline of the thinning area 11 by drawing a boundary line at the edges of the thinning area 11.

The manipulations and the drawings of boundary lines may be achieved by touch for a touch screen, or a pointing device such as a mouse, stylus pen, or other input device. Once the analysis is completed the results may be reported to the user in a certain form (e.g., graphs, text, email, video, etc.) (S440). The results may indicate that overtime the thinning area 11 has enlarged (e.g., signifying continuing hair loss) or that the thinning area 11 has remained the same or has been reduced in size (e.g., signifying a halt in hair loss or new growth). In some implementations, the sample images may be displayed in form of a moving picture to show the nature of the change in the size of the thinning area 11 overtime in a perceptible or animated manner.

In one embodiment, in addition or in exclusion to the above process, the app may be used to help a user to capture an image of a reference surface, such as a sheet of paper—preferably the sheet of paper has a solid color that is in contrast to the user's hair color. The user may use his hand(s), a comb or a brush, or other suitable object, to respectively shake, comb, brush or otherwise displace his or her hair over the reference surface for a certain amount of time, and preferably at a predefined distance from the surface. As an example, a light-colored surface is recommended for those with dark hair and a dark-colored surface is recommended for those with fair colored hair so that the hairs that are shed as the result of the above acts may be viewed and imaged easily against the reference surface.

In one implementation, the app may be configured to provide step-by-step instructions and cues to the user to start and end the above disclosed actions. The app may then instruct the user to take a picture of the reference surface and the fallen hairs on the surface. Optionally, the app may be enabled to interface with the photo enabled computing device 14 so as to cause the device to automatically take a picture of the reference surface once the perimeters of the surface or other detectable boundaries (e.g., edges of a page) fit into the screen view finder 21. This process would allow for the picture to be taken from the same distance and angle every time, if the same surface perimeters are used each time. In such an embodiment, the size of the surface perimeter is not important but it would be desirable that the same perimeters, lighting and background color are used for image capture uniformity and consistency of the samples taken overtime, leading to more accurate results.

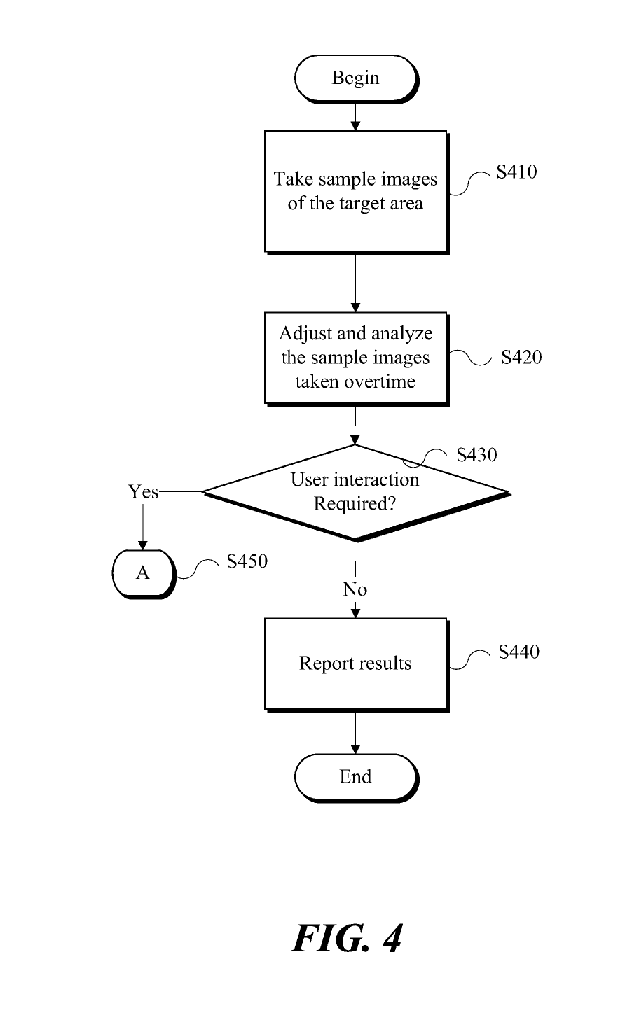

Using image recognition and a similar series of steps as disclosed in FIG. 4, the app may be configured to take several sample images of the target reference surface or area and adjust the images to be able to analyze them by, for example, counting the hairs in the captured image. The App may query the user to confirm the count. If automatic counting is not possible or accurate, the user may be given the option to intervene to provide a more accurate count. The user may count and input the number of hairs or touch each hair he or she sees on the image (on a touch screen equipped device) or use the mouse, stylus pen or other input device to identify each hair on the image. The app may be configured to record a touch or mouse click input by the user as one hair (i.e., one count). Ultimately, the total lost hair count for each sample is recorded as a numerical value with dates and times to plot progress charts for the user as the sampling is repeated over time.

In one embodiment, the app reminds the user on regular intervals to repeat the sampling (e.g., weekly, bimonthly, or according to a user-specified time interval). In an exemplary scenario, in order to have accurate measurements, each time the sampling is conducted the app reminds the user to shake his or her hair for the same period of time, with the same intensity, using the same surface used for the first sample and to hold his head at the same angle and distance from the surface. An increase in the number of lost hair counts would suggest continued hair loss, and a decrease in the count would suggest the reversal or status quo.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

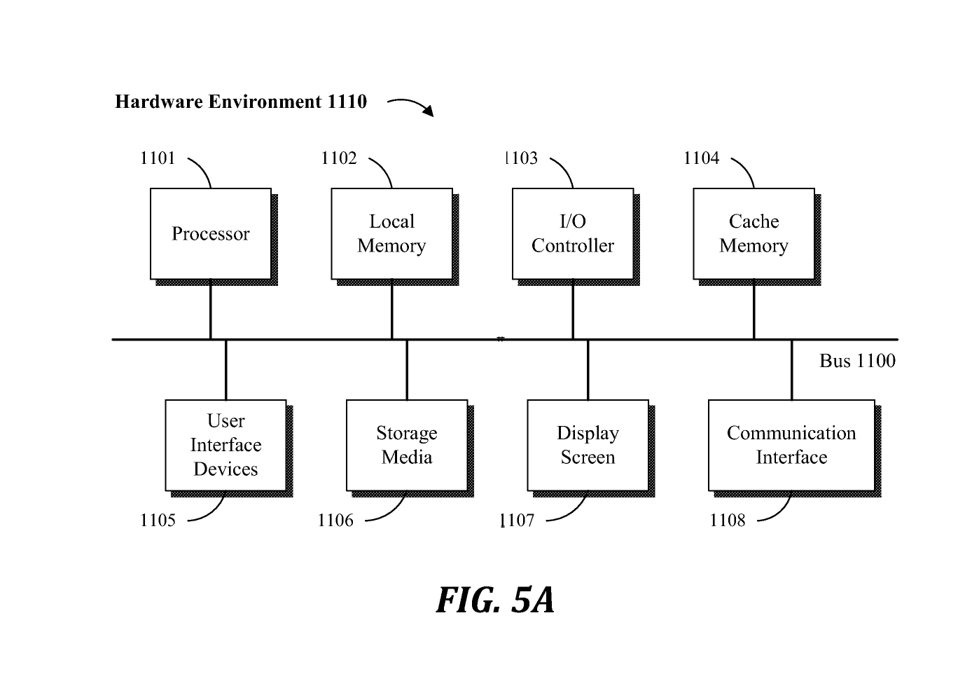

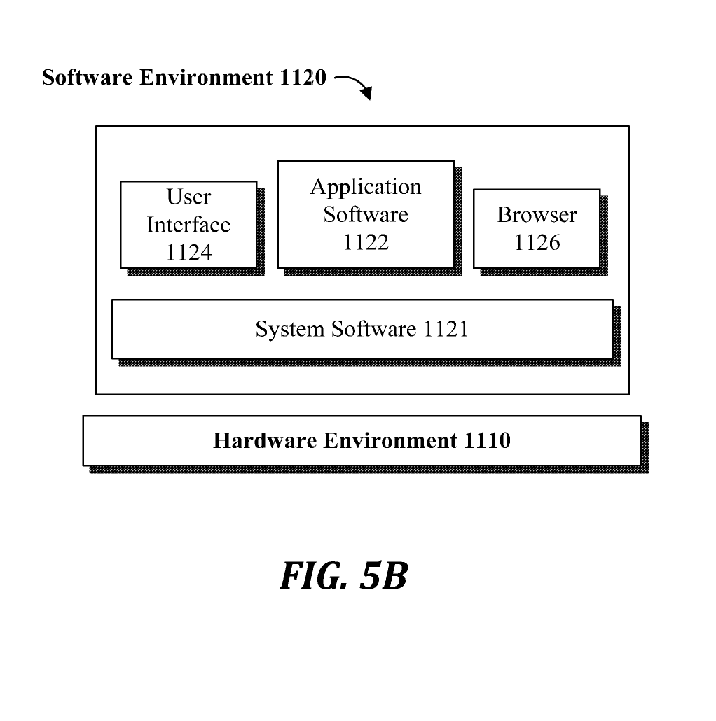

Referring to FIGS. 5A and 5B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 5A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 5B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for monitoring the degree with which hair loss improves or progresses over time, the method comprising:
capturing an image of a thinning area of hair using a photo enabled computing device such that the thinning process may be quantified; and
determining change in thinning rate by comparing the captured image with previously captured images.

2. The method of claim 1, wherein the photo enabled computing device comprises a portable phone with software executed on the phone to analyze the captured images to determine the change in the thinning rate.

3. The method of claim 1, wherein the images are captured during predetermined time intervals.

4. The method of claim 3, wherein the images are captured from a same distance at each time interval.

5. The method of claim 1, wherein the thinning process is quantified by determining a change in size of the thinning area.

6. The method of claim 5, wherein the size of the thinning area is
calculated and is compared to size of one or more thinning areas in previously captured images.

7. A method for monitoring hair loss, the method comprising:
capturing an image of one or more strands of hair collected on a surface area using a photo enabled computing device;
counting number of strands of hair in the captured image using software running on the photo enabled computing device;
determining hair loss or hair gain by keeping a record of number of strands of hair counted in a series of images captured over a course of time.

8. The method of claim 1, wherein the photo enabled computing device comprises a portable phone.

9. The method of claim 7, wherein record of the number of strands of hair counted over the course of time is presented in form of a graph to provide a visual presentation indicating hair loss or hair gain over time.

10. The method of claim 7 wherein the strands of hair are collected as a result of shaking a subject's hair over the surface area.

11. A system for monitoring the degree with which hair loss improves or progresses over time, the system comprising:
a photo enabled computing device for capturing an image of a thinning area of hair using such that the thinning process may be quantified; and
a logic unit having one or more processors for determining change in thinning rate by comparing the captured image with previously captured images.

12. The system of claim 11, wherein the photo enabled computing device comprises a portable phone with software executed on the phone to analyze the captured images to determine the change in the thinning rate.

13. The system of claim 11, wherein the images are captured during predetermined time intervals.

14. The system of claim 13, wherein the images are captured from a same distance at each time interval.

15. The system of claim 11, wherein the thinning process is quantified by determining a change in size of the thinning area.

16. The system of claim 15, wherein the size of the thinning area is
calculated and is compared to size of one or more thinning areas in previously captured images.
